(19) United States
(12) Patent Application Publication
(10) Pub. No.: US 2021/0183115 A1
(43) Pub. Date: Jun. 17, 2021

(54) PROCESSING VISUAL INFORMATION FOR DISPLAY ON A SCREEN

(71) Applicant: DISPLAYLINK (UK) LIMITED, Cambridge (GB)

(72) Inventors: Ian Christopher DOIDGE, Cambridge (GB); Paul JAMES, Lincolnshire (GB); Patrick David COOPER, Cambridge (GB)

(21) Appl. No.: 16/770,775

(22) PCT Filed: Nov. 27, 2018
(86) PCT No.: PCT/GB2018/053418

§ 371 Date: Jun. 8, 2020

(30) Foreign Application Priority Data
Dec. 8, 2017 (GB) 1720526.1

(51) Int. Cl. G06T 11/00; G06K 9/32; G06T 1/20

(52) U.S. Cl. CPC G06T 11/001; G06T 1/20; G06K 9/3233

(57) ABSTRACT

A Virtual Reality or Augmented Reality (VR/AR) system includes a central control unit and a user display device. A method of processing visual information for display on the user display device involves comprising: determining (802) a first region and a second region of a frame of visual information, discarding (804) visual information corresponding to the second region of the frame, processing (806) visual information corresponding to the first region of the frame, obtaining (810) replacement visual information corresponding to the second region of the frame, displaying (812) the visual information corresponding to the first region of the frame on a first portion of the screen and displaying the replacement visual information on a second portion of the screen. The visual information of the first region of the frame is transmitted from the central control unit to the user display device subsequent to discarding the visual information corresponding to the second region of the frame. This is particularly useful when the information contained within the second region of the frame is not useful for the user experience.

Processing visual information for display on a screen

This invention relates to methods of processing and displaying visual information, in particular on defined portions of a screen, particularly in the context of Virtual Reality (VR) and Augmented Reality (AR) systems.

It is important within the field of VR/AR to provide a high quality image delivered with a consistently high frame rate, contributing to an immersive user experience. This is especially important in VR/AR systems due to the proximity of the user's eyes to the screen. To achieve this, a low latency is required to prevent a significant time lag between a user's interaction with the system and its display; this requires a large volume of processing in a short interval of time. Typically a desired frame rate is 90 fps, or even 120 fps, and target latencies are under 10 ms. If the frame rate drops significantly, the experience can be less immersive and crucially may also contribute to motion sickness for the user. Consequently, there is a drive to improve the display quality of visual information to improve the user experience. The demands for such high quality images with high resolutions and colour depth presented at high frame rates has led to problems in a system being able to deliver the desired data at the required rate.

To present a high quality image on a screen at a consistently high frame rate, a vast amount of data must be transferred along a visual processing and transmission chain from a graphics source to display on a screen. Any element of the processing chain may experience an excessive load which causes a delay in data transmission and hence may cause a drop in quality or frame rate. For example, the rendering stage may cause a bottleneck by providing an output data rate which is insufficient to transfer the data at the required rate. The encoding and decoding stages may not be able to cope with the load and may be unable to output data at the required rate. The bandwidth of communication links such as a wireless transmission may experience fluctuations and be insufficient to transfer the data at the required rate.

Disclosed herein is a method of processing visual information for display on a screen in a

Virtual Reality or Augmented Reality (VR/AR) system comprising a central control unit and a user display device, the method comprising: determining a first region and a second region of a frame of visual information; discarding visual information corresponding to the second region of the frame; processing visual information corresponding to the first region of the frame; obtaining replacement visual information corresponding to the second region of the frame; displaying the visual information corresponding to the first region of the frame on a first portion of the screen and displaying the replacement visual information on a second portion of the screen, wherein the visual information of the first region of the frame is transmitted from the central control unit to the user display device subsequent to discarding the visual information corresponding to the second region of the frame. By determining a first and second region of the frame, wherein the visual information within the first region is processed, and the second region is discarded, the processing required to display a frame of visual information (e.g. in a virtual reality system) may be reduced. This is particularly useful when the information contained within the second region of the frame is not useful for the user experience.

In one embodiment concerning a VR/AR system, the first region corresponds to an effective visual area on a screen, or an expected field of view of the user. Optionally, the region is magnified by a lens to form the field of view of a user of the VR system.

Accordingly, the second region may correspond to an area outside of the effective visual area or expected field of view of the user.

The effective visual area may be defined by the area of a screen that is within the capture range of the lens, and hence displays a sharp and in-focus image to the user which may occur within their foveal visual region (the part of human vision having high visual acuity). This may depend on the position of the lens and the parameters of the lens defining the angles of incidence that may be captured. For instance, the area outside of the effective visual area may not be magnified by the lens, and will not show up in the user's field of view. As another example, the area outside of the effective visual area may be partially magnified, and appear as a blurry region towards the outer edges of the user's field of view.

It should be noted that the discarding of visual information corresponding to the second region of the frame does not necessarily mean that all of the visual information must be discarded. For example it may mean that the location of individual pixels and their visual information is discarded, whereas a colour average of at least some part of the second region is retained. This information may be transmitted and used at a later stage for reforming the replacement visual information. Optionally, in some embodiments the entirety of visual information corresponding to the second region is discarded, for example to maximise the decrease in load and bandwidth required to present a frame.

By discarding the visual information of the second region before transmitting the visual information, the visual information of the second region does not need to be transmitted. This will save valuable bandwidth in a wireless system, where the volume of information to be transmitted is often a bottleneck in the performance of such systems. For example, by reducing the volume of information that is transmitted over the wireless link, the speed of data transfer can be increased, which may decrease latency or enable an increase in frame rate of display of the visual information. In other cases it may allow the visual information of the first region to be transmitted and displayed in a higher quality e.g. higher resolution. Each of these may improve the user experience.

A central control unit of a VR/AR system may be used to receive visual information of a frame from a graphics source, and prepare this visual information for transmission to a user display device. The central control unit may, by way of example, comprise a graphics processing unit (GPU) which receives visual information from a graphics source, an encoder to encode and optionally compress data, and a transmitter to transmit data wirelessly or via cables. The central control unit may comprise other processing means for processing the visual information. In one embodiment, the central control unit is a base station possessing a substantial amount of the system processing power, wherein the visual information may be wirelessly transmitted to a user display device.

The user display device may, by way of example, comprise a receiver configured to receive the visual information from the central control unit (wirelessly, or via cables), a decoder to decode and optionally decompress the received data, and a screen which may further comprise a rasteriser to display the received visual information onto the screen. The user display device may comprise other processing means for processing the visual information. In one embodiment, the user display device is a headset worn by a user of a VR/AR system, configured to receive the visual information transmitted from the central control unit.

In this manner, the components that make up the central control unit and user display device form a processing and transmission chain that may include the steps of receiving the visual information, processing the visual information, preparing the visual information for transmission, transmitting the visual information, and displaying the visual information. For example, in one embodiment, the processing and transmission chain may comprise: a GPU, an encoder, a transmitter, a receiver, a decoder, a rasteriser, and a display.

The discarding step may occur at the same stage or a later stage in the processing and transmission chain than the determining step. The discarding step may be performed at any stage in the processing and transmission chain before the visual information is transmitted from the central control unit to the user display; in particular, it may be performed by any one of: a GPU, an encoder, a transmitter.

Reducing the number of components that process and transmit the visual information corresponding to the second region of the display may help to improve the efficiency in displaying the visual information of the entire frame. By reducing the load of the visual processing and transmission chain, the latency may be improved, and the chance of a drop in frame rate may be reduced. In a preferred embodiment, the discarding and determining step is performed as early as possible in the processing chain to maximise the efficiency savings. This may be achieved by the processing and transmission of the visual information relating to the first region of the frame, while the second region of the frame may be discarded and replacement visual information is displayed, which may be obtained at a point further down the processing and transmission chain.

The replacement visual information of the second region may be obtained and used to replace the previously discarded visual information corresponding to the second region. This may be useful if a rasteriser requires an input of a rectangular frame buffer to display an image on the screen. The replacement visual information can then be used to reform the full frame buffer to fill in the discarded second region.

Optionally, the obtaining step is performed subsequent to transmitting the visual information from the central control unit to the user display device. In a preferred embodiment, the obtaining of the replacement visual information may occur at a point in the processing and transmission chain later than the determining of a first and second region, meaning that at least a section of the processing and transmission chain handles the first region and not the second region. For example, in one embodiment, an encoder may receive only visual information corresponding to the first region, encode this and pass this on, wherein the replacement visual information corresponding to the second region is obtained at a later stage. Therefore the encoder does not need to encode the visual information corresponding to the second region. For example, in one embodiment, the decoder may decode the visual information of the first region and obtain the replacement visual information corresponding to the second region, and pass data relating to both regions on to be displayed.

In a preferred embodiment, where the system allows, the obtaining step is performed as late as possible, for example at the user display device such as at the decoder. In this manner, only the visual information of the first region is transmitted, giving the greatest efficiency savings. In other examples, this may not be possible and the obtaining step is performed at the central control unit, for example at the GPU or encoder.

In some systems, the user may not care about visual information displayed on the second portion of the screen, for example if the second region corresponds to an area outside of the effective visual area. Therefore, the corresponding information contained within the second region of the frame may not be useful to the user, or may not be visible at all. In an example virtual reality headset, the display screen is positioned in close proximity to the user's eyes, and the screen is magnified to the user by a lens for each eye. The lens will then magnify the effective visual area defined by the properties and positioning of the lens such that the effective visual area is displayed as the user's field of view. This may mean that the positioning of the lenses relative to the display limits the view of the rest of the display to the user, meaning that the portion of the screen outside the effective visual area of the lenses may not be visible, or may appear blurry or out of focus. For example, in one embodiment, the first region of the frame may lie towards the centre of the screen, and the second region may lie towards the outer edges of the screen. Accordingly, the second region may correspond to an area out of the effective visual area that may be blocked or poorly focused due to the positioning of the lenses, and is not useful for displaying images to the user. This may typically contribute to around 10-15%, or even 20%, of the total display area.

In an embodiment such as this, the determining may be based on visual models of the human eye. For example, the determining of the first region may be based on visual models determining areas of good magnification of the lenses into the user's eyes, and the second region may be based on areas of poor magnification. In one embodiment, the first region of the frame corresponds to the field of view of the user, and the second region of the frame is displayed with replacement visual information. This is advantageous because it may allow the visual information contained within the second region of the frame to be discarded and not unnecessarily processed by every component in the processing and transmission chain between the source and the display. This is especially important if the visual information in the second region is not visible to the user.

Mass-produced displays are typically manufactured as rectangular panels, and, while technically feasible, custom-shaped displays are currently not very common and expensive to have manufactured for consumer electronics. Therefore, rectangular screens are typically used to display images of various shapes and contents, for example even where an outer section of the screen is not used. Previously, as images have been displayed on rectangular screens such as television screens, computer monitor screens, or mobile phone screens, a rectangular frame buffer has been used to contain information about pixels to be displayed within the rectangular shape of the screen. In screens, for example used for displaying virtual reality frames, the visible part of the screen observed by the viewer may comprise a substantially circular shape, defined by the effective visual area and hence the positioning of the magnifying lenses in the headset. This means that the outer section of the screen outside of the effective visual area determined by the positioning of the lenses is not easily viewable by the user, and remains wasted display space, resulting in unnecessary processing to display pixels within this area.

Optionally, the determining step is performed by one or more of the following devices: a graphics processing unit; an encoder; a transmitter; and/or processing means at the central control unit. This allows the processing and transmission chain to have flexibility on how to implement the determining of the first and second regions and the consequent discarding of the second region and the processing of the first region. In particular, it is advantageous to perform the determining step at the central control unit before the visual information is transmitted. In this way, the efficiency savings are maximised.

Optionally, the method comprises the determining step being dynamically assigned to at least one of the devices above, based on the load, performance, and/or bandwidth corresponding to the devices. If one of the devices is busy, then the determining task may be passed to another device, which may improve efficiency. For example, if the graphics processing unit is busy then another element such as the encoder may take on the task of determining the first and second region, discarding the second region and processing and passing on visual information of the first region. This load balancing may help the system overcome any bottlenecks that occur due to the vast amount of data that flows along the processing and transmission chain at high rates. Optionally, the dynamic allocation of the task may be controlled by a central processing unit such as within a host system wherein it may receive reports relating to the load of each device and makes a decision to dynamically assign the determining step to a particular device based on the parameters above. This central processing unit may be included within the central control unit. However, the dynamic allocation may also be handled locally wherein each device either accepts or refuses the task based on the parameters e.g. its load or its capability of performing the task. By dynamically switching the device that performs this task, the system can become more efficient and prevent the data being presented at a lower quality or lower frame rate.

Optionally, the method includes the replacement visual information for display in the second portion of the screen being obtained by one or more of: a graphics processing unit; an encoder; a transmitter; a receiver; a decoder; a rasteriser; and/or a display. The replacement visual information may be obtained by an element of the central control unit or the user display device. In a preferred embodiment, the obtaining step is performed at an element of the user display device, such that the obtaining step is performed subsequent to the transmitting of the visual information. In this manner, the replacement visual information is not transmitted, leading to savings in bandwidth, which may be particularly important for a wireless link. For example, the GPU may determine the first and second regions of a frame, and may process and pass on the data corresponding to the first region, meanwhile discarding the data corresponding to the second region. At a later stage, a different device such as the decoder may perform the task of obtaining the replacement visual information corresponding to the second region, which may comprise retrieving the information from memory, and pass on the visual information of the first and second regions, re-establishing a full frame. This allows the processing chain between the GPU and the decoder to handle the visual information corresponding to the first region and not the second region, improving the efficiency. The obtaining step may be performed by any of the devices; the later the visual information corresponding to the second region is obtained, then the fewer devices that must process this data, maximising the efficiency savings.

However, in some cases the obtaining step may be performed at a stage before transmission, for example at the encoder. For example, in some cases the elements of the user display device may have a high processing load and may be unable to cope with the task of obtaining the replacement visual information. In other cases, the elements of the user display device may have substantially less processing power than elements of the central control unit. This may be the case in situations where the user display device is a small, wireless VR headset. In this case, the obtaining step may be performed at the central processing unit, where most of the processing power is located.

Optionally, the obtaining step is dynamically assigned to at least one of the devices based on the load, performance, and/or bandwidth corresponding to the devices. The dynamic allocation of which device will perform the determining of a first region and a second region in a frame of visual information, and which device will perform the obtaining replacement visual information corresponding to the second region allows for flexibility in the system to cope with load bottlenecks.

However, these tasks may be performed at various devices along the processing and display chain. For instance, the determining of the first and second regions may be performed by the encoder if the GPU is busy. Optionally, the method provides a load-balancing feature that may take advantage of devices with a lower current load. If the bandwidth is limited, then the method may allocate the encoder to perform the task of determining the first and second regions, wherein the allocation may consider for example the bandwidth available, the current load of each device along the processing and transmission chain, and the processing capabilities of each component. For example, it may only be possible to perform the determining step at a particular device in a legacy system.

Optionally, the method provides a dynamic allocation of which device in the chain will obtain the replacement visual information corresponding to the second region. For example, if the display is busy, then the obtaining may be performed by the decoder. The system can select which device can carry out the obtaining of the visual information of the second region based on the load of the device, processing capabilities of the device, load of the rest of the system and potential bottlenecks including the available bandwidth.

Optionally, the dynamic assigning of the task may be controlled by a central processing unit such as within a host system where it may receive reports relating to the load of each device and makes a decision to dynamically assign the determining or obtaining to a particular device based on the parameters above. However, the dynamic allocation may also be handled locally where each device either accepts or refuses the task based on the parameters e.g. its load.

Optionally, the position of the first region corresponds to the effective visual area of the display and the position of the second region corresponds to an area of the display outside of the effective visual area. The effective visual area may be defined by the area of a screen that is within the capture range of the lens. This may depend on the position of the lens and the parameters of the lens defining the angles of incidence that may be captured. For example, light originating from an area outside of the effective visual area may not be captured by lenses, and hence is not displayed to the user. As another example, the area outside of the effective visual area may be partially magnified, and appear as a blurry region towards the outer edges of the user's field of view.

Optionally, the method comprises the position of the first region being within the expected field of view of a user, and the position of the second region being outside the expected field of view of the user. As the skilled person will appreciate, the terms “first region” and “second region” in this context can be interpreted to mean the regions of the frame that, after processing and display, map onto the first and second portions of the screen respectively, the first portion of the screen being within the expected field of view of the user and the second portion of the screen being outside the expected field of view of the user. This may vary depending on the layout and format of the screen or display device and therefore the originally-defined portions may vary accordingly. In this embodiment the visual information of the second region would not be viewed by the user, and as such would require unnecessary processing. This embodiment provides a more efficient way of handling the data required for display to the user, while minimising a reduction in quality of the visual information within the expected field of view of the user and hence the user experience, but at the same time provides a reduced load on the visual processing and transmission chain. The expected field of view of the user may be defined by the properties and positioning of the lenses.

Optionally, the determining of the first and second regions is based, at least in part, on the positioning of lenses relative to the screen. The positioning of the lenses relative to the screen may affect the effective visual area on the display which corresponds to the field of view of the user. For instance, the lens may accept light from the display at a defined range of angles, forming an area of the screen that is captured by the lens and correspondingly magnified to the user. Light originating from the display at angles greater than this (from positions outside of the effective visual area), may not be captured by the lens and may not be viewable to the user.

By basing the determining of a first and second region on the positioning of lenses, the regions can be defined by the quality of magnification experienced by the user. For example, the lenses may not magnify the second region well if it lies outside of the effective visual area of the lenses, meaning that the second region appears blurry, out of focus, or is not visible at all. This effect can be adjusted by varying the location of the boundary around the effective visual area. Consider an example wherein the first region is a set size and the second region corresponds to an area that appears blurry. If the first region is then increased in size, the second region may then correspond to an area that is not visible as it is no longer within the capture area of the lenses. For example, the size of the first region may be adjusted depending on the bandwidth available. The size of the first region relative to the effective visual area may affect the visibility of the second region. Each frame that is determined may consider parameters such as the available bandwidth or load, and make adjustments to the relative size of the first and second regions compared to the previous frame based on this.

Optionally, the position and relative size of the first and second region is changed based, at least in part, on the available resources. The method is not necessarily limited to the effective visual area defined by the position of the lenses, and may be adjusted such that the first region extends beyond the effective visual area to provide a more immersive experience, or may be adjusted such that the second region extends into the effective visual area to reduce the processing required by displaying more replacement visual information. In other words, the size of the first region may be increased or decreased around a general shape determined by the effective visual area, depending on the requirements or limitations of the system. It should be noted that the positioning of the first and second regions is also not limited to the positioning of the lenses. These two determinations of different sized first and second regions may be provided such that a larger first region is displayed when sufficient resources are available (e.g. sufficient bandwidth), and the smaller first region is displayed where resources are more limited (e.g. low bandwidth, or high load on devices in the processing and transmission chain).

In one embodiment, the position of the first and second regions is adjusted based on an adjustment made to the positioning of the lenses relative to the screen. For example, if the position of the lenses is adjustable, the area of the display visible to the user may change, and the system may be able to compensate by adjusting the boundary between the first and second regions, allowing, for example, the effective visual area of the display to be adjusted according to any adjustment in the positioning of the lenses. For example, if a child were to use the same headset as an adult, the position of the lenses may be adjusted to bring them closer together to compensate for the child's eyes being closer together. A headset may be adjustable to vary the position and separation of the lenses to improve comfort and user experience. Optionally, the method comprises an adjustment to the positioning of the first and second regions to compensate for any change in position of the lenses. In some cases, the lenses can be physically moved closer or further apart which in turn will change the region that is visible to the user. Consequently, software used for displaying the visual information can be notified of this change and respond accordingly by repositioning the visual information on the screen. In some examples, the determining of the first and second regions may also be based on other information such as user settings and calibrations. Optionally, the location of the boundary between the first and second regions is based, at least in part, on a radial distance from the centre of the visible area of the screen. In one example the location may be based on an elliptical model. A more precise model based on the realistic shapes of the lens system, and accounting for the use of two lenses (one for each eye), may be used to provide, for instance, a binocular-shaped boundary between the first and second regions.

Optionally, the position of the first and second regions may be based, at least in part, on the position of a user's eye relative to the screen. For example, when a user's eyes are closer to a screen, a larger portion of the screen is displayed in the user's periphery, and a smaller portion of the screen is central to the user's eyes. Furthermore, a user viewing the screen from a non-central location or from an angle will observe different parts of the screen as central to his eyes or in his periphery. Optionally, eye-tracking software can be used to determine the location of a user's eyes relative to the screen and/or the direction in which the user's eyes are pointing. This may also comprise basing the position of the first and second region on the expected positioning of the user's eyes using these techniques.

Optionally, the method further comprises determining at least one border region in the frame of visual information, disposed between the first region and the second region; processing visual information corresponding to the at least one border region of the frame; transmitting the visual information corresponding to the at least one border region of the frame from a central control unit to a user display device subsequent to discarding the visual information corresponding to the second region of the frame; displaying the visual information corresponding to the at least one border region of the frame on a third portion of the screen disposed between the first portion and the second portion of the screen; optionally wherein the visual information corresponding to the at least one border region corresponds to the first region, second region, or is generated anew. A third, border region may be determined between the first and second regions wherein the border region may act as an intermediary region to display visual information. The determining the border region may be performed at the same stage in the processing and delivery chain as the determining of the first and second regions, or it may be performed at a different stage. The border region may be displayed with visual information corresponding to the first region, the second region, or separate visual information. In one embodiment, the border region may be displayed with a higher resolution version of the replacement visual information of the second region. Consider a case where the second region is filled with visual information of a single colour e.g. black. To save processing load, this can be of a very low resolution, for example presented in large tile sizes. Because these tiles are so large, as they approach the boundary with the first region, the boundary is not smooth and may, for example, appear as a jagged edge on the periphery of in the user's field of view. A border region could be used to display the replacement visual information of the second region (in this case black pixels) at a higher resolution i.e. smaller tile sizes. In this case the border region could be used to smooth the boundary between the first region and the second region and hence smooth the boundary along the edge of the field of view of the user, improving the immersive experience for the user.

The border region may also be used to extend the first region to cover the periphery of the field of view. For example consider a case where the system experiences a heavy load and consequently reduces the size of the first region meaning the field of view is slightly reduced. At a later point, the system has more resources available and wishes to expand the field of view of the user. The border region may then be displayed with information corresponding to the first region. Optionally, this may comprise a colour average of at least part of the first region in order to provide a more immersive display at the periphery of the field of view.

For example, for the purposes of visualisation of this embodiment, the first region may be surrounded by an annular border region, the annular region surrounded by a second region in which replacement visual information is displayed. Note that this annular embodiment is not limiting and the border region may comprise a region that does not surround the entirety of the first region, and is not entirely surrounded by the second region. In this example, whether the border region is displayed with visual information corresponding to the first region or replacement visual information corresponding to the second region is dependent on the resources available. Furthermore, the annular region may comprise replacement visual information of a higher quality than the second region outside of the annular region. For example, this may comprise visual information of a higher resolution, higher frame rate, or may comprise an average of the colour of the first region. In this scenario, the border region may comprise visual information corresponding to the first region, replacement visual information corresponding to the second region, or further replacement visual information that may be a high quality version of the replacement visual information of the second region.

Optionally, the method comprises a first region comprising one or more circular shapes or ellipses.

Optionally, the method comprises the first region being divided into a plurality of sub-regions. Also, the method may optionally comprise the second region being divided into a plurality of sub-regions. For example, one embodiment may concern a system corresponding to a display providing visual information to each eye in a virtual reality system. In this embodiment, the frame may comprise a first region comprising a plurality of sub-regions, for which the visual information is to be processed and transmitted, and a second region optionally comprising a plurality of sub-regions, comprising replacement visual information which may optionally be fetched from memory.

In one example, multiple areas of a screen may be displayed with replacement visual information. For example, if a screen contains two visible regions, e.g. one for each eye, the replacement visual information (e.g. lying outside the field of view) may be displayed in the outer portions of the screen outside the portions that correspond to the effective visual area, and also may be displayed in a portion of the screen between the two lenses if this portion is not within the effective visual area and hence magnified well by the lenses.

Optionally, the method may comprise the sub-regions being not contiguous. The plurality of sub-regions may be continuously joined, or exist as separate entities. Optionally, the sub-regions of the first region are not contiguous. In some cases the sub-regions of the second region are not contiguous.

Optionally, the sub-regions may contain the same visual information (e.g. they may all be black), or they may each be processed independently and contain different visual information.

Optionally, the replacement visual information corresponding to the second region of the frame is retrieved from memory. This may not require transmission in the same way as the visual information corresponding to the first region. This means that the load on elements of the processing and transmission chain can be reduced, improving the performance of the system and reducing the chances of a quality drop in the presented visual information. The replacement visual information corresponding to the second region optionally comprises a single colour, e.g. black. In one embodiment, this may comprise displaying black pixels in a second portion of the screen corresponding to the second region of the frame. By being able to retrieve the information from memory, the replacement information does not need to be transmitted, reducing the processing and bandwidth required to transmit a frame along the chain. By not creating the information from scratch, extra processing is also not required if it can be retrieved from memory.

Optionally, the replacement visual information of the second region is generated anew, optionally wherein the generated replacement visual information is based, at least in part, on the visual information of the first or second region, or an average colour of at least part of the first or second region. For example, the replacement second region visual information could be based in part on a colour average taken of the first region. As a further example, before visual information corresponding to the second region is discarded, a colour average can be taken which could be transmitted along with the first region visual information. This colour average can then be used to generate at least a part of the replacement second region. This may be important in cases where light from pixels close to the boundary can bleed into the region of the screen visible to the user, and may affect the visual seen by the user.

Optionally, the replacement visual information of the second region comprises a single colour. For example, the second region could comprise visual information corresponding to black pixels.

In one case, the method may comprise the replacement visual information corresponding to the second region being transmitted at a lower rate than the first region, and optionally wherein the replacement visual information corresponding to the second region is displayed at a lower resolution than the first region. The second region may not require updating at the same high rate as the visual information of the first region, and the replacement visual information of the second region may not be encoded, transmitted and/or decoded repeatedly every frame. For example, if the second region is set to a single colour (e.g. black) the second region does not have to be updated every frame, further reducing the processing load. The visual information of the second region can be decoupled from the first region, and can be handled at a different rate. The display may still refresh every frame, and therefore the frame rate may be unchanged, but the second region may not contain new data, and may be the same as the previous frame.

Optionally, the replacement visual information of the second region may be displayed at a lower resolution than the first region. For example, if the second region corresponds to an area outside of the user's field of view, then the resolution of the second region is less important than the resolution of the first region. The resolution of the second region may change depending on the available resources/bandwidth. For example, when lower bandwidth/data rates are available, the resolution of the second region may be reduced. When more resources are available, the resolution of the second region may be increased. For example, the resolution of the pixels along the boundary of the first and second regions may increase, which may lead to a smoother edge to the periphery of the field of view of the user.

Optionally, the method may comprise the screen being divided into a series of tiles, wherein the display quality is uniform over each tile. It is also known to handle the displaying of a frame through the use of tiles, each containing a plurality of pixels. In practice, this may comprise treating tiles as single-colour areas to reduce the resolution, providing further efficiency savings. Dividing the screen into tiles made from a series of pixels can improve the efficiency in processing visual data. By displaying visual information at the same quality over the whole tile, each tile may be treated as a unit and consequently processed as such, rather than treating each pixel individually. This may be especially useful in the second region where replacement visual information is displayed within the second region. A tile may comprise any number of pixels, but in practice may be made up of e.g. 8×8, 8×64, or 64×64 pixels, where this number may depend on desired resolution or available resources. The second region may for example comprise tiles of a larger size than the first region, as a lower quality may be required in the second region. However, along the boundary between the first and second region, which may comprise a border region, and may also coincide with the periphery of the user's field of view, more detail may be required to account for the potentially curved boundary. In this case, smaller tiles may be used along the boundary to prevent a low resolution interruption to the user's periphery, and attempt to form a smooth boundary. On the other hand, a low resolution boundary comprising large tiles may occur at a position beyond the periphery of the user's field of view, wherein the user does not experience the low resolution boundary, and the first region extends beyond the user's field of view.

Optionally, the visual information of the second region comprises a colour average of at least part of the visual information of the first region. For example, if the image displayed within the visible first region corresponds to a sky-view, the replacement second region visual information may comprise a single colour, based on some average of at least some section of the first region, in this case a light blue region may be displayed on the second portion which may comprise the periphery of the display. This would be especially useful if the second region did not exactly cover the poorly magnified region, and encompassed a small portion of the effective visual area which may be at least partially visible to the user. In this embodiment, displaying some average of the first region in the second region may contribute to the overall immersive user experience. The area of the screen that displays a single colour in this embodiment may not be limited to the entirety of the second region. For example, a thin strip around the periphery of the lenses may be used to provide the necessary immersive colours, and the remainder of the second region of the frame may comprise different visual information. Equally, the colour average may be displayed on a sub-region of the second region, or on a border region described previously.

Optionally, the displaying of an average colour may be affected by the available resources for delivering data. For example, when the bandwidth is reduced, or a bottleneck occurs (e.g. the encoder is very busy and must reduce its load to prevent a frame rate drop), an average colour will not be displayed, and the second portion of the screen will be displayed with other replacement information, which may be retrieved from memory. When more resources are available, for example the bandwidth available increases, the quality of the visual information corresponding to the second region may be improved, for example a higher resolution may be used, or a colour average may be used.

Optionally, the method may comprise the visual information comprising video data.

Optionally, the method may comprise the screen being mounted in a headset configured to be worn on a user's head, for example in VR/AR systems.

In some cases, the headset may optionally comprise two screens, each one operating according to the method disclosed. The screens may be physically separated, or may form two sections of a single screen, divided into two parts (one for each eye). On the other hand, a single screen may display two regions—one for each eye. The method disclosed may be carried out independently in respect of visual information to be presented on each of the two screens. This allows the visual information to be displayed differently to the two eyes. For example, the determining of the first and second regions may be different on each screen, leading to a different size and shape of each region. If the display includes a feature such as a bright light towards one side of the screen, this may be enhanced through the use of a single colour area in the second region, in an attempt to improve the user immersion, which may be further enhanced by independently adjusting the two screens. For example, if there was a bright light towards the right hand side of the field of view, the screen for the right eye may include a brighter region around the right hand side of the periphery within the second region, while the left eye screen may comprise a less bright part of the second region towards the right side of the periphery, implying a bright object towards the right side of the user's periphery.

Disclosed herein is a method of displaying visual information on a screen in a Virtual Reality or Augmented Reality (VR/AR) system comprising a central control unit and a user display device, comprising: determining a first region and a second region of a frame of visual information; discarding visual information corresponding to the second region of the frame; processing visual information corresponding to the first region of the frame; rasterising visual information corresponding to the first region of the frame and forming a frame buffer in the shape of the first region of the frame; displaying visual information corresponding to the first region of the frame on a screen in the shape of the first region of the frame. In one embodiment where the first region of the frame is circular, a circular frame buffer may be formed which in one embodiment may correspond to the effective visual area or the field of view of the user, while the second region of the frame is discarded which may comprise an area of the screen outside of the effective visual area or outside of the field of view of the user.

Optionally, the shape of the first region of the frame is substantially elliptical. In some cases, the shape of the first region of the frame is circular, however oval, semi-circular, polygonal or other shapes are possible.

Optionally, the method further comprises transmitting the visual information corresponding to the first region of the frame between the central control unit and the user display device. Preferably, the transmitting occurs subsequent to the steps of determining and discarding.

A rasteriser that is able to handle a frame buffer in the shape of the first region (which may be non-rectangular e.g. circular) may be used to process the first region of the frame and display this visual information on a screen which may be custom to its function. For example, if the first region comprises a circular shape within a rectangular frame, the outer second region may be discarded and the first region processed. The rasteriser may then rasterise the first region and display the first region on a screen such as a circular screen, where the second region is not displayed with replacement visual information. An advantage of this relative to the previous methods is that the replacement visual data of the second region does not need to be obtained, and the visual information can be displayed without re-forming a rectangular frame buffer.

An apparatus for presenting visual information on a screen in a Virtual Reality or Augmented Reality (VR/AR) system comprising a central control unit and a user display device, and the apparatus comprising: means for determining a first region and a second region of a frame of visual information; means for discarding visual information corresponding to the second region of the frame; means for processing visual information corresponding to the first region of the frame; means for transmitting the visual information of the first region of the frame from a central control unit to a user display device subsequent to discarding the visual information corresponding to the second region of the frame; means for obtaining replacement visual information corresponding to the second region of the frame; and means for displaying the visual information corresponding to the first region of the frame on a first portion of the screen and displaying the replacement visual information on a second portion of the screen.

An apparatus for presenting visual information on a screen in a Virtual Reality or Augmented Reality (VR/AR) system comprising a central control unit and a user display device, and the apparatus comprising: a source of visual information; a graphics processing unit; and a screen; wherein the apparatus is configured to carry out the method previously disclosed. Optionally, the apparatus comprises an encoder to compress and encode the visual information, and a decoder to decode and decompress the visual information. The apparatus may also comprise a transmitter and receiver for transmitting the visual information wirelessly between the central control unit and the user display device. The information may also be transmitted via cables. The data source may comprise a disc e.g. CD, DVD, Blu-Ray etc. and suitable reading apparatus. The data source may also comprise streaming information from an antenna or satellite dish, or transmission over the internet. The apparatus may further comprise processing means at the central control unit. The apparatus may further comprise a rasteriser. The apparatus may further comprise processing means at the user display device.

Optionally, the screen is mounted in a headset configured to be worn on a user's head. By processing the visual information corresponding to the first region and displaying replacement visual information for the second region, the load of the visual processing and transmission chain can be reduced. Optionally, the apparatus further comprises a second screen. Optionally, the apparatus is configured to carry out the method disclosed independently in respect of visual information to be presented on each of the two screens.

Disclosed herein is a central control unit for preparing visual information for transmission in a Virtual Reality or Augmented Reality (VR/AR) system, comprising: means for determining a first region and a second region of a frame of visual information; means for discarding visual information corresponding to the second region of the frame; means for processing visual information corresponding to the first region of the frame; and means for transmitting the visual information of the first region of the frame from a central control unit to a user display device subsequent to discarding the visual information corresponding to the second region of the frame. For example, the central control unit may comprise a GPU, an encoder, and a transmitter.

Optionally, the central control unit further comprises means for obtaining replacement visual information corresponding to the second region of the frame.

Disclosed herein is a user display device for displaying visual information in a Virtual Reality or Augmented Reality (VR/AR) system, comprising: means for receiving visual information corresponding to a first region and a second region of a frame of visual information; means for processing visual information corresponding to the first region of the frame; means for obtaining replacement visual information corresponding to the second region of the frame; and means for displaying the visual information corresponding to the first region of the frame on a first portion of the screen and displaying the replacement visual information on a second portion of the screen. For example, the user display device may comprise a receiver, a decoder, a rasteriser, and a display.

Optionally a computer program, computer program product or computer readable medium is provided, comprising instructions for implementing the method disclosed.

Specific examples will now be described in detail, with reference to the Figures, in which:

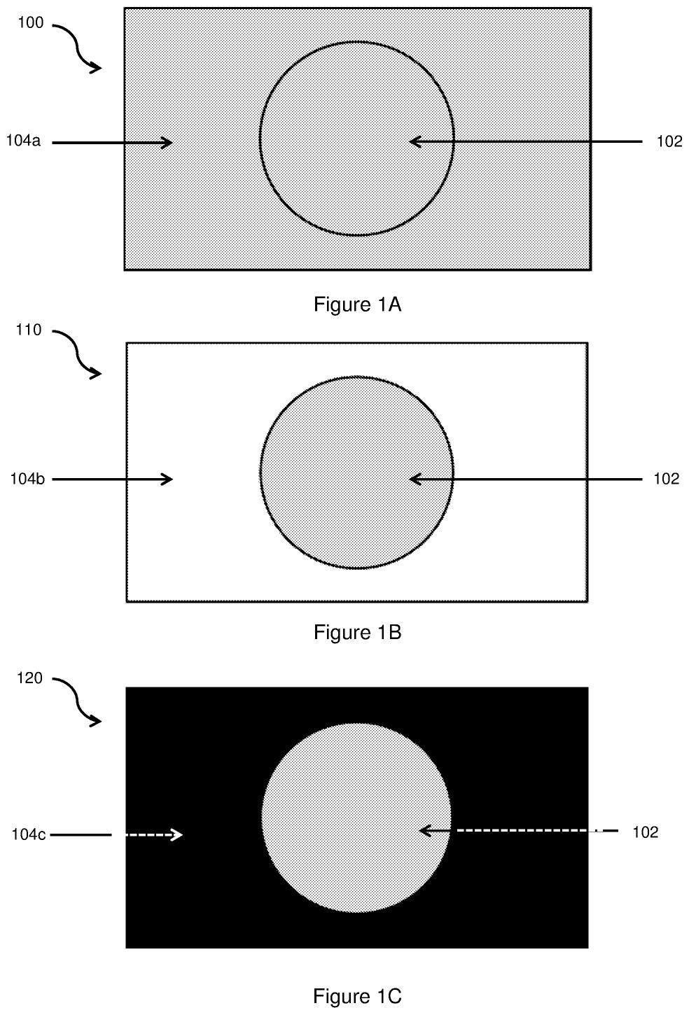

FIG. 1A shows a frame of visual information determined into two regions, according to one embodiment;

FIG. 1B shows a frame determined into two regions according to one embodiment, wherein the second region has been discarded;

FIG. 1C shows a frame according to one embodiment, wherein the second region has been filled with replacement visual information;

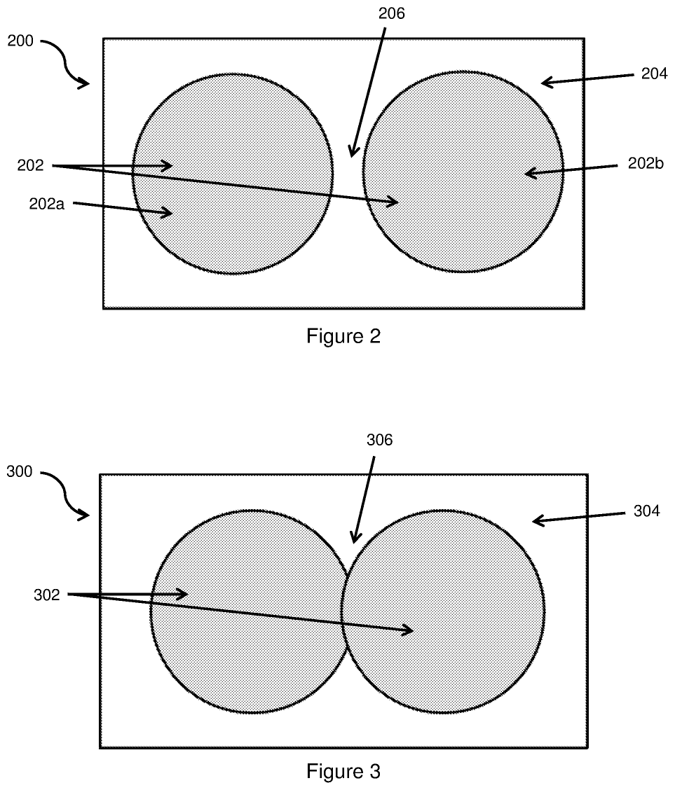

FIG. 2 shows a frame according to one embodiment, with a first region comprising two sub-regions;

FIG. 3 shows a frame according to one embodiment, with a first region comprising two sub-regions, wherein the sub-regions are not contiguous;

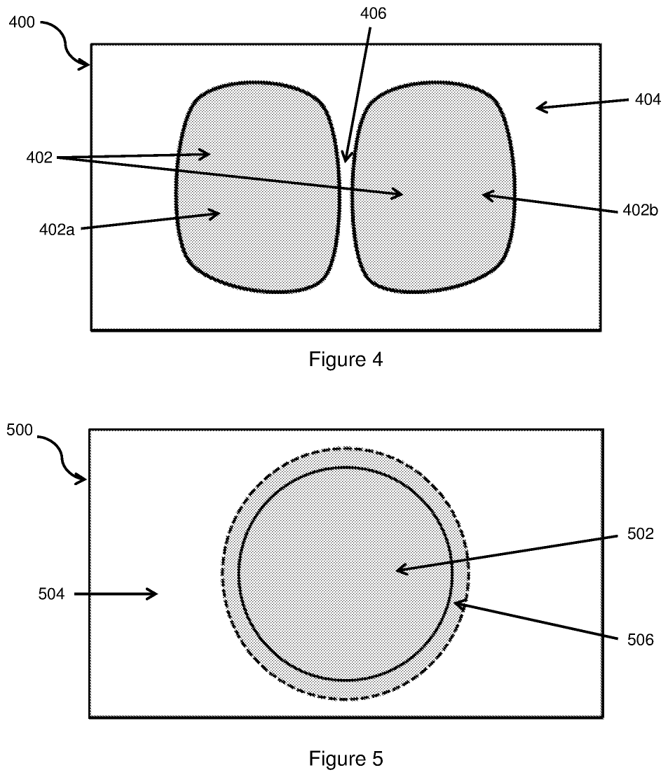

FIG. 4 shows a frame according to one embodiment, with a first region comprising two sub-regions, wherein the sub-regions are non-circular.

FIG. 5 shows a frame according to one embodiment, determined into a first region, a second region, and a border region.

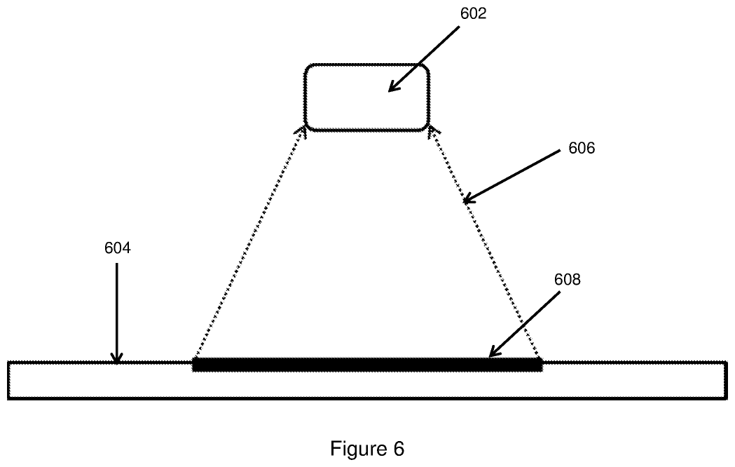

FIG. 6 shows a side profile of the effective visual area formed by a lens capturing light emitted from a display screen, according to one embodiment.

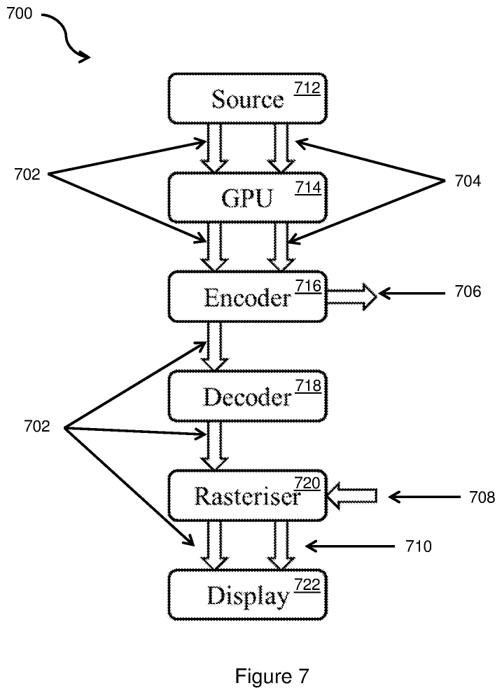

FIG. 7 shows a flowchart illustrating one embodiment of the method disclosed, wherein the determining and discarding step is performed by the encoder, and the obtaining step is performed by the rasteriser.

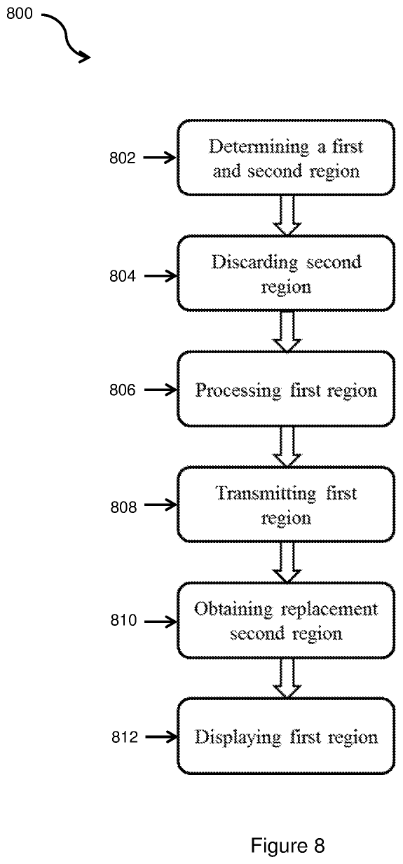

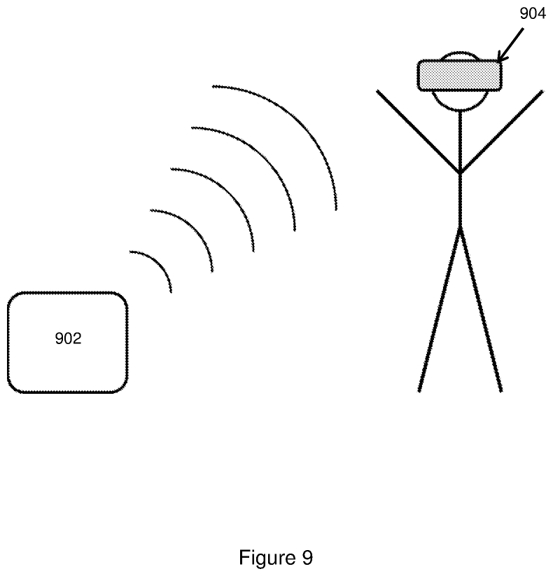

FIG. 8 illustrates a method of processing visual information for display according to one embodiment.

FIG. 9 is a schematic diagram of the system according to one embodiment.

FIG. 1 shows an example of how the most useful visual information may be preserved and displayed to the user, saving processing load by not processing or transmitting the original data for the second region, and instead obtain replacement visual information for the second region, for instance filling the second region with black pixels.

FIG. 1A shows a frame of visual information 100 which may be displayed on a screen, the frame comprising a first region 102, and a second region 104a, and is an example of how a first and second region may be determined in a frame. FIG. 1A shows a frame of visual information received from a source, containing visual information (shown in the Figure in grey) in a first region 102 and a second region 104a. For example, in this embodiment the first region 102 is towards the centre of the screen and the second region 104a is towards the outer edges of the screen. In some cases, the first region 102 may not be centred at the centre of the screen. The shape of the first region may be derived from a visual model, e.g. one which determines the first region to be a foveal (high visual acuity) region, or it may be a simple geometric shape. In FIG. 1A the first region is circular, but it may be elliptical, or some polygon incorporating some region within the frame 100. In use, a frame 100 may be displayed on a screen mounted in a headset, where a lens may be positioned relative to the screen to magnify the image into the user's eye. The boundary between the first and second regions is nominal in FIG. 1, but can be based upon parameters such as the area of the display which corresponds to the effective visual area, or the field of view of the user. The shape of the first region 102 may be determined by the shape of a lens, for example if a lens has a circular profile relative to the screen, the first region 102 may be a corresponding circular shape, in order to provide first region 102 as the visible area magnified to the user.

FIG. 1B shows a frame 110 where the visual information of the first region 102 has been kept, and the visual information corresponding to the second region of the frame 104b has been discarded. This has been illustrated with the first region 102 in grey, and the second region 104b has been left blank. This is an example embodiment of how the first region of information could be extracted and processed along the visual processing and transmission chain, and the visual information corresponding to the second region could be discarded, improving the processing speed.

FIG. 1C shows frame 120 containing visual information corresponding to the first region 102, and the second region 104c has been displayed with replacement visual information. This has been illustrated with the first region 102 in grey, and the second region 104c has been filled with black, illustrating one possible embodiment.

FIG. 2 shows a frame 200 which has been determined into a first region 202, and a second region 204. The first region 202 has been divided into two sub-regions 202a and 202b. These sub-regions may be physically separated and not contiguous, or they may overlap as in FIG. 3. In FIG. 2, each first region 202 may correspond to an image to be displayed to each eye of the user, with each region having its own lens to magnify the image from the screen to the user's eye. In this case, the method may comprise a first region 202 divided into a plurality of sub-regions (e.g. 202a and 202b) which may contain the visual information desired, and may discard the visual information of the second region 204. This embodiment demonstrates that the first region 202 is not limited to the centre of the frame, and the second region 204 is not limited to the outer edges of the screen, and in fact may comprise a section of the frame between the plurality of sub-regions 202a and 202b; an example of which has been illustrated at 206.

FIG. 3 shows a frame 300 as a variation of FIG. 2, wherein the first region 302 comprises a continuous shape that may comprise images destined for each eye. This illustrates how the shape of first region 302 may take an irregular shape and the first region may be divided into sub-regions that are contiguous, may overlap, and may not be physically separated. FIG. 3 also demonstrates how the second region 304 may comprise elements that surround the first region 302 but are not necessarily towards the outer edges of the frame 300; an example of which has been illustrated at 306.

FIG. 4 shows a frame 400 with a variation of FIG. 2, with the first region 402 is divided into sub-regions 402a and 402b, wherein the sub-regions are typical shapes used in virtual reality eye pieces.

FIG. 5 shows a variation of FIG. 1 wherein a frame 500 comprises a first region 502 and a second region 504 wherein the visual information of the second region has been discarded and may be replaced with replacement visual information. FIG. 5 also comprises a border region 506 which illustrates an example of a border region as an annulus. Border region 506 may be displayed with replacement visual information corresponding to second region 504, or some other generated or obtained visual information which may be, but not limited to, one of the following: a colour average of at least part of the first region, a colour average of at least part of the second region, a lower resolution version of the visual information displayed in the first region, a higher resolution version of the visual information displayed within the second region, visual information of the second region displayed in smaller tile sizes as to improve the resolution of the boundary between the first and second regions. The positioning of the border region 506 is not limited to that shown in FIG. 5. The border region 506 is disposed between the first and second regions, and does not have to surround the entirety of the first region. The border region 506 may overlap with the first region 502 or the first region 506, wherein a section of either region may be displayed with different visual information corresponding to the border region 506. For instance, the visual information corresponding to the first region may be processed, and at a later stage (e.g. due to limited resources) the border region may be displayed with a higher resolution version of the replacement visual information that is due to be displayed in the second region. For instance, if the second region was to be displayed with black pixels with large tile sizes, the border region may display black pixels with smaller tile sizes, forming a smoother border.

FIG. 6 shows the positioning of a lens 602 relative to a screen 604 such that captured light 606 from the screen that enters and is captured by the lens is sent to the user, magnifying the image displayed on the screen. Part of the light emitted from the screen will be incident on the lens and will undergo necessary refraction to be transmitted through the lens and sent to the user. The amount of light 606 that is captured by the lens is dependent on the geometry and properties of the lens, for example it is only able to refract light at certain angles. This creates an effective visual area 608 of the display 604 that is captured by the lens and sent to the user. This illustrates how the effective visual area can be a useful parameter on which to base the determining a first and second region of a frame.

FIG. 7 shows a flowchart that illustrates an example visual processing and transmission chain 700 from a graphics source to display on a screen. The elements of the chain illustrated include a graphics source 712, a graphics processing unit (GPU) 714, an encoder 716, a decoder 718, a rasteriser 720, and display screen 722. The method is not limited to these devices; FIG. 7 is an embodiment showing example elements of a processing and transmission chain. Actions 702 represent the transmission of the processed visual information corresponding to the first region of a frame from a device (the device being an element of the processing chain 700) to the next device in the chain, following the processing of the visual information of the first region at the respective device. For example, the GPU 714 may receive the data from the source 712 and then process the data by rendering the necessary graphics for a frame of visual information. The GPU 714 may then transmit this data to the encoder 716, passing it along the chain. Therefore, the label 702 represents the passing of processed data of the first region along the chain. Action 704 represents the passing of processed visual information corresponding to the second region of a frame along the chain. The combined actions 702 and 704 cause the transmission of both the first and second regions of a frame. Actions 702 and 704 are shown separately in FIG. 7; this does not limit the interpretation to mean that the frame must already be determined into a first and second region at the point. In fact, the determining can be performed at any stage in the process before the transmission, in this case from the encoder to the decoder.

Action 706 represents an instance where a device discards the visual information corresponding to the second region. This step may comprise the determining of a first and second region of a frame, but is not limited to this, for example the determining may have been performed at a previous stage, and the necessary information transmitted alongside the visual information. Action 706 occurs at the encoder 716 in FIG. 7, but this action can occur at any stage in the process before transmission. In this embodiment, the encoder 716 then undergoes action 702 representing the transmission of the visual information of the first region along the chain to the next device (in this case to the decoder 718) and does not undergo action 704, because the visual information of the second region is not transmitted and is, rather, discarded during action 706.

The consequent actions 702 represent further transmission stages of the first region information, and the associated processing by each device. For example, in FIG. 7 after the encoder 716 discards the second region, it encodes the first region and sends this to the decoder 718. The decoder receives the information and decodes only the first region, meaning the processing involving encoding/decoding required by the encoder 716 and the decoder 718 is reduced. The decoder 718 then transmits the decoded first region data to the rasteriser 720 through action 702. These actions 702 can occur at any point until the frame is displayed on the display screen 722.

The action 708 comprises the obtaining of replacement visual information corresponding to the second region of a frame, which may be retrieved from memory. FIG. 7 shows a rasteriser 720 performing the task of obtaining the replacement visual information corresponding to the second region of a frame, however, this task can be carried out at any stage along the chain. Preferably this is performed after the transmission. The rasteriser 720 performs action 710 in sending the obtained replacement visual information corresponding to the second region to the next device, which in this case is the display 722. The rasteriser 720 also performs action 702 in sending the visual information corresponding to the first region to the display 722. The effect is that the display 722 receives the visual information of the first region along with the replacement visual information of the second region, while elements of the chain between the encoder 716 and the rasteriser 720 do not have to handle the visual information of the second region. This can improve the processing speed of the chain, and reduces the bandwidth requires to transmit a frame, particularly if a wireless link is in place between the encoder 716 and the decoder 718.

FIG. 7 shows an example implementation of the method disclosed, and does not limit the method to determining the first and second regions on the encoder 716, and obtaining the replacement visual information on the rasteriser 720. Therefore, the number of processing elements of the chain that only handle the first region of visual information may vary. This may depend on the bandwidth available, or the processing load or abilities of each component. FIG. 7 also does not limit the method to be carried out on the processing elements illustrated in the flow chart. For example, a separate compression/decompression stage may occur to the encoder/decoder. For example, a transmitter or receiver may comprise processing means to perform the actions 702, 704, 706, 708, or 710. Each device of the chain may be a separate entity, or its functionality may be combined. For example, the rasteriser 720 may exist within a display unit, and the illustrations of FIG. 7 should not limit the scope of the method by defining particular devices that can handle the actions disclosed.

FIG. 8 is a flow chart representing an example of the method disclosed of processing visual information for display on a screen in a Virtual Reality or Augmented Reality (VR/AR) system comprising a central control unit and a user display device. First step 802 represents the determining of a first region and a second region of a frame of visual information. For example, this may be performed at an encoder located in the central control unit. Second step 804 represents discarding visual information corresponding to the second region of the frame. For example, this may be performed at the same stage as the determining step 802, or at a later stage. Step 806 represents processing visual information corresponding to the first region of the frame. This step may be performed at any stage in the process, and may be performed on a plurality of occasions. For example, the visual information may be processed at each element of the processing and transmission chain, both in the central control unit and in the user display device. The step 808 represents the transmitting of the visual information of the first region of the frame from the central control unit to the user display device subsequent to discarding the visual information corresponding to the second region of the frame. For example, this may be transmitted over a wireless link between a transmitter and a receiver. In FIG. 8 this is shown between the processing and obtaining steps. However, in some embodiments, the transmitting step 808 could occur after the obtaining step 810. The step 810 represents the obtaining of replacement visual information corresponding to the second region of the frame. This may be performed at the central control unit or at the user display device. Step 812 represents the displaying of the visual information corresponding to the first region of the frame on a first portion of the screen and displaying the replacement visual information on a second portion of the screen. For example, this may be performed by a display unit comprising a rasteriser, a frame buffer, and at least one display screen.

FIG. 9 shows an example embodiment of the apparatus for presenting visual information on a screen in a Virtual Reality or Augmented Reality (VR/AR) system comprising a central control unit 902 and a user display device 904. The central control unit 902 may for example comprise means for determining a first region and a second region of a frame of visual information; means for discarding visual information corresponding to the second region of the frame; means for processing visual information corresponding to the first region of the frame; and means for transmitting the visual information of the first region of the frame from a central control unit 902 to a user display device 904 subsequent to discarding the visual information corresponding to the second region of the frame. In FIG. 9, the central control unit 902 is shown as a base station, and user display device 904 is shown as a wireless headset. The central control unit 902 may comprise most of the processing power of the VR system, allowing the user display device to be lightweight and easily wearable by a user.

Optionally the central control unit 902 comprises means for obtaining replacement visual information corresponding to the second region of the frame. In one embodiment the central control unit may comprise means for receiving a frame of visual information, for example reading from a disk, or obtaining from a source such as streaming over the internet. The central control unit 902 may also comprise a graphics processing unit, an encoder, and a transmitter for transmitting the processed visual information to the user display device 904. The transmitter may also be configured to transmit audio information from the central control unit 902 to the user display device 904.

The user display device 904 may for example comprise means for receiving visual information corresponding to a first region and a second region of a frame of visual information; means for processing visual information corresponding to the first region of the frame; means for obtaining replacement visual information corresponding to the second region of the frame; and means for displaying the visual information corresponding to the first region of the frame on a first portion of the screen and displaying the replacement visual information on a second portion of the screen. For example, the user display device 904 may comprise a display screen to be positioned in front of the user's eyes, and lenses to magnify the visual information to the user's eyes, and in some cases to transform it into an interpretable image. The user display device 904 may also comprise a receiver for receiving the transmitted visual information from the central control unit 902. For example, this may comprise at least one antenna. The user display device may comprise a speaker for outputting sound received from the central control unit 902.

The above embodiments and examples are described by way of example only and are in no way intended to limit the scope of the present invention as defined by the appended claims.

1. A method of processing visual information for display on a screen in a Virtual Reality or Augmented Reality (VR/AR) system comprising a central control unit and a user display device, the method comprising:
determining a first region and a second region of a frame of visual information;
discarding visual information corresponding to the second region of the frame;
processing visual information corresponding to the first region of the frame;
obtaining replacement visual information corresponding to the second region of the frame;
displaying the visual information corresponding to the first region of the frame on a first portion of the screen and displaying the replacement visual information on a second portion of the screen;
wherein the visual information of the first region of the frame is transmitted from the central control unit to the user display device subsequent to discarding the visual information corresponding to the second region of the frame.

2. The method of claim 1, wherein the obtaining step is performed subsequent to transmitting the visual information from the central control unit to the user display device.

3. The method of claim 1 wherein the replacement visual information for display in the second portion of the screen is obtained by one or more of the following devices:
a graphics processing unit;
an encoder;
a transmitter;
processing means at the central control unit;
a receiver;
a decoder;
a rasteriser;
a display; and/or
processing means at the user display device.

4. The method of claim 3, wherein the obtaining step is dynamically assigned to at least one of the devices based on the load, performance, and/or bandwidth corresponding to the devices.

5. (canceled)

6. The method of claim 1, wherein the replacement visual information of the second region is generated anew, optionally wherein the generated replacement visual information is based, at least in part, on the visual information of the first or second region, or an average colour of at least part of the first or second region.

7. The method of claim 1, wherein the replacement visual information of the second region comprises a single colour.

8. The method of claim 1, wherein the replacement visual information of the second region is transmitted at a lower rate than the first region, and optionally wherein the replacement visual information of the second region has a lower resolution than the first region.

9. The method of claim 1, wherein the replacement visual information of the second region comprises a colour average of at least part of the visual information of the first region.

10. (canceled)

11. (canceled)

12. (canceled)

13. (canceled)

14. The method of claim 1, wherein the position of the first region corresponds to the effective visual area of the display and the position of the second region corresponds to an area of the display outside of the effective visual area and/or wherein the position of the first region is within the expected field of view of a user and the position of the second region is outside the expected field of view of the user.

15. (canceled)

16. (canceled)

17. (canceled)

18. The method of claim 1, wherein the position and relative size of the first and second region is changed based, at least in part, on the available resources.

19. The method of claim 1, wherein the position of the second region is based, at least in part, on a radial distance from the centre of the screen.

20. (canceled)

21. The method of claim 1, further comprising:
determining at least one border region in the frame of visual information, disposed between the first region and the second region;
processing visual information corresponding to the at least one border region of the frame;
transmitting the visual information corresponding to the at least one border region of the frame from a central control unit to a user display device subsequent to discarding the visual information corresponding to the second region of the frame;
displaying the visual information corresponding to the at least one border region of the frame on a third portion of the screen disposed between the first portion and the second portion of the screen;
optionally wherein the visual information corresponding to the at least one border region corresponds to the first region, second region, or is generated anew.

22. (canceled)

23. (canceled)

24. (canceled)

25. (canceled)

26. (canceled)

27. (canceled)

28. (canceled)

29. The method of wherein the screen is mounted in a headset configured to be worn on a user's head, wherein the headset comprises two screens, each one operating as set out in any preceding claim.

30. (canceled)

31. The method of claim 1, wherein the method is carried out independently in respect of visual information to be presented on each of the two screens.

32. (canceled)

33. An apparatus for presenting visual information on a screen in a Virtual Reality or Augmented Reality (VR/AR) system comprising a central control unit and a user display device, and the apparatus, the apparatus comprising:
a source of visual information;
a graphics processing unit; and
a screen;
wherein the apparatus is configured to carry out a method comprising:
determining a first region and a second region of a frame of visual information;
discarding visual information corresponding to the second region of the frame;
processing visual information corresponding to the first region of the frame;
obtaining replacement visual information corresponding to the second region of the frame;
displaying the visual information corresponding to the first region of the frame on a first portion of the screen and displaying the replacement visual information on a second portion of the screen;
wherein the visual information of the first region of the frame is transmitted from the central control unit to the user display device subsequent to discarding the visual information corresponding to the second region of the frame.

34. The apparatus of claim 33, comprising:
an encoder;
a decoder;
a transmitter;
processing means at the central control unit;
a receiver;
a rasteriser; and/or
processing means at the user display device.

35. The apparatus of claim 33, wherein the screen is mounted in a headset configured to be worn on a user's head.

36. The apparatus of claim 33, further comprising a second screen.

37. The apparatus of claim 36, further configured to carry out the method independently in respect of visual information to be presented on each of the two screens.

38. (canceled)

39. (canceled)

40. (canceled)

41. A computer program, computer program product or computer readable medium comprising instructions for implementing a method comprising:
determining a first region and a second region of a frame of visual information;
discarding visual information corresponding to the second region of the frame;
processing visual information corresponding to the first region of the frame;
obtaining replacement visual information corresponding to the second region of the frame;
displaying the visual information corresponding to the first region of the frame on a first portion of the screen and displaying the replacement visual information on a second portion of the screen;
wherein the visual information of the first region of the frame is transmitted from the central control unit to the user display device subsequent to discarding the visual information corresponding to the second region of the frame.
